(19) United States
(12) Patent Application Publication
(10) Pub. No.: US 2019/0063770 A1
(43) Pub. Date: Feb. 28, 2019

(54) HVAC SYSTEM INCLUDING THERMOSTAT WITH AUTOMATIC COMPONENT REPLACEMENT CAPABILITIES

(71) Applicant: Trane International Inc., Davidson, NC (US)

(72) Inventors: Vinoth Vairamudi, Chennai (IN); John Hughes, Flint, TX (US); Karl J. Mutchnik, Tyler, TX (US); Gregory S. Brown, Flint, TX (US); Satish Mukundan Thiruvengadam, Chennai (IN)

(73) Assignee: Trane International Inc., Davidson, NC (US)

(21) Appl. No.: 15/687,125

(22) Filed: Aug. 25, 2017

(51) Int. Cl. F24F 11/00; F24F 11/02; G05B 15/02; G06Q 10/08

(52) U.S. Cl. CPC F24F 11/006; F24F 11/02; G05B 15/02; F24F 2011/0071; F24F 2011/0052; F24F 2011/0063; G06Q 10/087

(57) ABSTRACT

A system configured for automatic replacement of peripheral components of a heating, ventilation and air condition (HVAC) system is provided. The system includes a thermostat in operable communication with at least one peripheral component of the HVAC system and a server in operable communication with the thermostat and a manufacturer for providing the manufacturer with a status of the at least one peripheral component.

### BACKGROUND

### Field of the Disclosure

The present disclosure generally relates to a heating, ventilation and air conditioning (HVAC) system, and more particularly, to an HVAC system including a thermostat with automatic component replacement capabilities.

### Description of the Related Art

HVAC systems which regulate environmental conditions within an enclosed area of a commercial building (or residential home) are known. Residential HVAC systems are typically controlled by a thermostat, e.g., a smart thermostat. With respect to commercial buildings, the HVAC systems are typically controlled by a building automation system (BAS) or HVAC equipment control system. The thermostat or BAS can also be used to control security, lighting, power, etc. of the building.

Conventional BASs and/or thermostats can be configured to monitor a status of connected HVAC peripherals, e.g., a humidifier, a humidifier pad, an ultra violet (UV) light, an air filter, a media filter, a collection cell, a ventilation system service, etc.

While the aforementioned thermostats and/or BASs are suitable for providing a status of the peripheral components, such thermostats and/or BASs do not provide for automatic replacement of the peripheral components.

### SUMMARY

The present disclosure has been made to address the above problems and disadvantages, and to provide at least the advantages described below. Accordingly, an aspect of the present disclosure provides an HVAC system including a thermostat with auto replacement capabilities, such that when a lifetime of one or more components of the HVAC expires, the smart thermostat can automatically reorder the expired component.

In accordance with an aspect of the present disclosure, there is provided a system configured for automatic replacement of peripheral components of a heating, ventilation and air condition (HVAC) system. The system can include a thermostat in operable communication with at least one peripheral component of the HVAC system and a server in operable communication with the thermostat and a manufacturer for providing the manufacturer with a status of the at least one peripheral component.

The at least one peripheral component can be a humidifier, a humidifier pad, an ultraviolet light, an air filter, a media filter, a collection cell, a ventilation and system service, a filter screen, an electrode of an air filter, or an in force field filter (IFD).

The server can be a dealer diagnostics portal associated with the manufacturer, and the server can send a notification to one of the manufacturer and a user of the thermostat as a result of receiving a control signal from the thermostat; the notification can be an email, a text, or a telephone call. Depending on an auto-subscription service selected by the user, the notification can be displayed on the thermostat either prior to or after the control signal is sent to the server, thereby allowing the user to confirm a reorder of the at least one peripheral component.

The thermostat can be configured to provide a graphical user interface (GUI) that allows a user to enroll in the auto-subscription service provided by the server.

In accordance with an aspect of the present disclosure, there is provided a method for automatic replacement of peripheral components of a heating, ventilation and air conditioning (HVAC) system. The method can include monitoring a status of at least one peripheral component of the HVAC system using a thermostat that is in operable communication with the at least one peripheral component of the HVAC system and a server, sending a control signal from the thermostat to the server, and sending a notification to one of a manufacturer and a user of the thermostat upon receiving the control signal.

The method can include displaying a graphical user interface (GUI) that allows a user to enroll in an auto-subscription service provided by the server, and can include processing a subscription to the auto-subscription service.

The at least one peripheral component can be a humidifier, a humidifier pad, an ultraviolet light, an air filter, a media filter, a collection cell, a ventilation and system service, a filter screen, an electrode of an air filter, and an in force field filter (IFD).

The server can be a dealer diagnostics portal associated with the manufacturer.

The method can also include sending by the server a notification to one of the manufacturer and a user of the thermostat as a result of the server receiving a control signal from the thermostat. Sending the notification can include sending an email, a text, or a telephone call, and depending on an auto-subscription service selected by the user, the method can include displaying a notification on the thermostat, either prior to or after the control signal is sent to the server, thereby allowing the user to confirm a reorder of the at least one peripheral component.

In accordance with an aspect of the present disclosure, there is provided a building automation system (BAS) for controlling a heating, ventilation and air condition (HVAC) system. The BAS includes a processor in operable communication with at least one peripheral component of the HVAC system and a server that is in operable communication with a manufacturer for providing the manufacturer with a status of the at least one peripheral component when the server receives a control signal generated by the processor.

The at least one peripheral component can be a humidifier, a humidifier pad, an ultraviolet light, an air filter, a media filter, a collection cell, a ventilation and system service, a filter screen, an electrode of an air filter, and an in force field filter (IFD).

The server can be dealer diagnostics portal associated with the manufacturer.

### BRIEF DESCRIPTION OF THE DRAWINGS

The embodiments of the present invention may be more completely understood in consideration of the following detailed description of various embodiments in connection with the accompanying drawings, in which:

FIG. 1 is a diagram of a system including a thermostat, according to an embodiment of the present disclosure;

FIG. 2 is a diagram of a graphical user interface displayed on the thermostat of FIG. 1;

FIG. 3 is a diagram of another graphical user interface displayed on the thermostat of FIG. 1; and

FIG. 4 is a flowchart of a method for automatic replacement of peripheral components of an HVAC system, according to an embodiment of the present disclosure.

The various aspects of the present disclosure mentioned above are described in further detail with reference to the aforementioned figures and the following detailed description of embodiments.

### DETAILED DESCRIPTION

The systems and methods of the invention can be utilized in a residential, local or widely distributed HVAC system, from a single family unit or building to an enterprise level, encompassing virtually any structure, cluster, campus, and areas therebetween. Systems and methods for residential and commercial HVAC control are disclosed in U.S. patent application Ser. No. 11/208,773, now U.S. Pat. No. 8,050,801, filed Aug. 22, 2005, entitled “Dynamically Extensible and Automatically Configurable Building Automation System and Architecture” and U.S. patent application Ser. No. 15/186,715 (U.S. Patent Publication No. 2016/0370023), filed Jun. 20, 2016, entitled “Fault Detection and Diagnostics System Utilizing Service Personal Feedback for Improved Accuracy,” both of which are assigned to the assignee of the present application, and are herein incorporated by reference.

As noted above, smart thermostats and/or BASs do not provide for automatic replacement of the peripheral components. Accordingly, an HVAC system including a thermostat (or an HVAC system that is controlled by a BAS) with auto replacement capabilities is now herein described. For illustrative purposes, the aspects of the present disclosure will be described herein with reference to a thermostat.

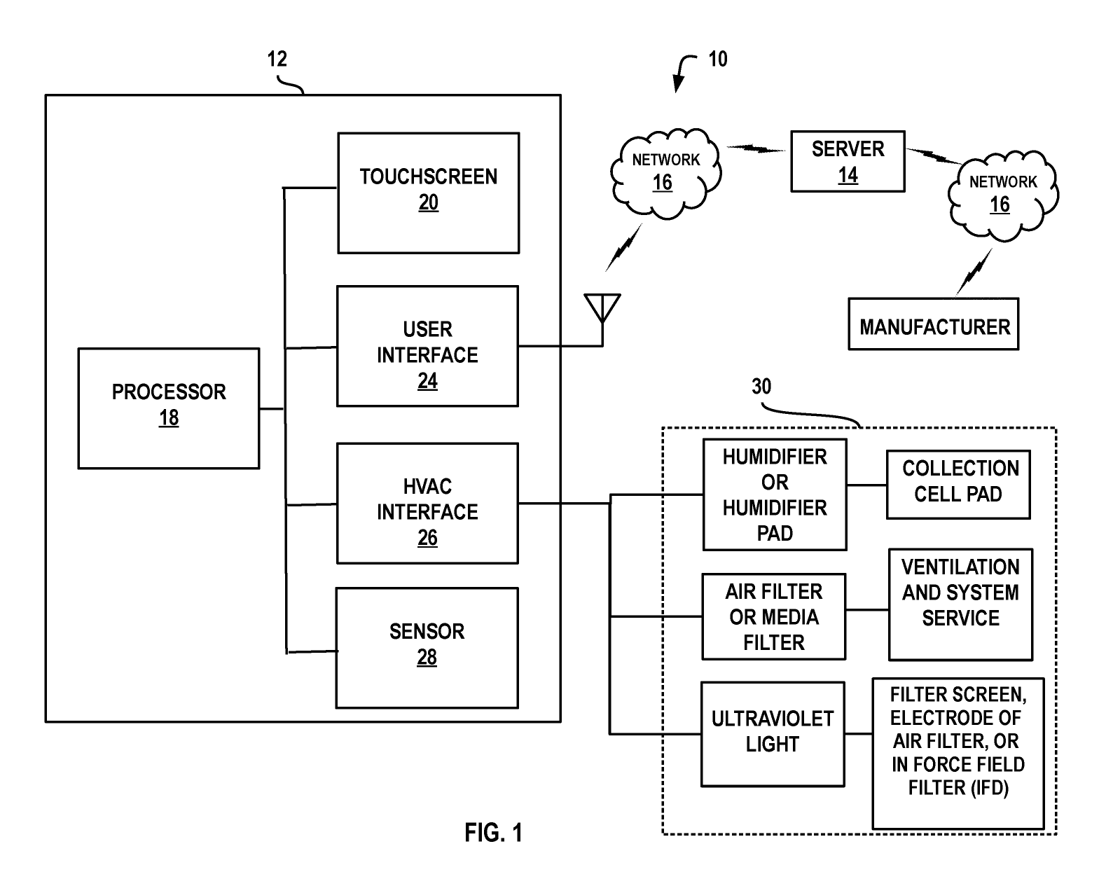

FIG. 1 is a diagram of a system 10 including a thermostat 12 that is in operable communication with a server 14 (or portal) via a network 16, according to an embodiment of the present disclosure. The server 14 also communicates with a manufacturer (or dealer) of the thermostat 12 and/or a manufacturer of an HVAC system that is controlled by the thermostat 12 via the network 16.

The thermostat 12 includes a processor 18 (or controller), a touch screen 20, a memory 22, a user interface (UI) 24, an HVAC interface 26, and a sensor 28, which monitors one or more peripheral components 30 of the HVAC system, as will be described in greater detail below.

When the processor 18 is a component of a BAS (i.e., HVAC system is operable in a commercial environment), the processor 18 controls the overall operation of the HVAC system and can communicate, via a wired or wireless interface, with the components of the HVAC system. For example, the processor 18 can communicate with the components of the HVAC system using a wireless communication protocol including, without limitation, any variant of IEEE 802.11 (commonly known as WiFi), variants of IEEE 802.15 wireless personal area networking such as Bluetooth® and ZWave®, and other wireless standards such as ZigBee® or the AirFi™ protocol promulgated by Trane International Inc. of Davidson, N.C., USA. Alternatively, the processor 18 can be configured to communicate using a wired protocol using dedicated data lines (e.g., Ethernet), via powerline communication links using, for example, IEEE 1901 and/or X10®, or via a dual-band (wireless plus powerline) protocol such as the Insteon® protocol.

Likewise, when the processor 18 is a component of an HVAC system used in a residential environment, the processor 18 can control the overall operation of the HVAC system, via the HVAC interface 26, and can be configured for communication with the one or more peripheral components 30 via the network 16 (which may include a LAN and/or the public internet). The HVAC interface 26 may be configured to communicate between thermostat 12 and the one or more peripheral components 30 using any communications protocol suitable for use with the system. For example, and without limitation, where indoor units, outdoor units, and/or furnaces (not explicitly shown) employ single- or dual-speed motors, HVAC interface 26 may include a 24V switched circuit interface which operates with well-known HVAC color-coded wiring schemes (Rc, Rh, C, Y, W, Y2, W2, G, E, O, V, etc.). Where the indoor units and/or outdoor units employ variable-speed motors, HVAC interface 26 may include a digital signaling interface such as, without limitation, CANbus, RS-485, ComfortLink II™, ClimateTalk™, and the like. In embodiments, HVAC interface 26 may operate using both 24V switched circuits and digital signaling protocols to flexibly accommodate any combination of HVAC equipment. In embodiments, any of the functions of data interface 14 may be performed by HVAC interface 26, and vice versa. In embodiments, HVAC interface 26 may be incorporated within data interface 14.

Additionally or alternatively, the processor 18 can be configured for communication with one or more remote devices that are in operable communication with the HVAC system via network 16 (which may include a LAN and/or the public internet). The remote device may include, without limitation, a mobile device (smart phone, tablet computer, and the like) and/or the remote server 14 (such as a dealer diagnostic portal, a fuel marketplace server, a weather data provider, other data providers, and so forth). Furthermore, the processor 18 can be configured to communicate using a wide area cellular mobile network using, for example and without limitation, a GSM protocol (3G, 4G, LTE etc.), a CDMA protocol (EV-DO, SV-DO, etc.), and so forth.

The processor 18 can include a data interface module (not shown), which can function as a WiFi/AirFi™ hot-spot or wired router to enable the processor 18 and/or the components of the HVAC system (e.g., the thermostat 12) or other components (e.g., one or more smart devices including, without limitation, a smart watch, a smart phone, a smart tablet, smart remote, etc.) in operative communication with the processor 18 to connect to the network 16 (or the Internet).

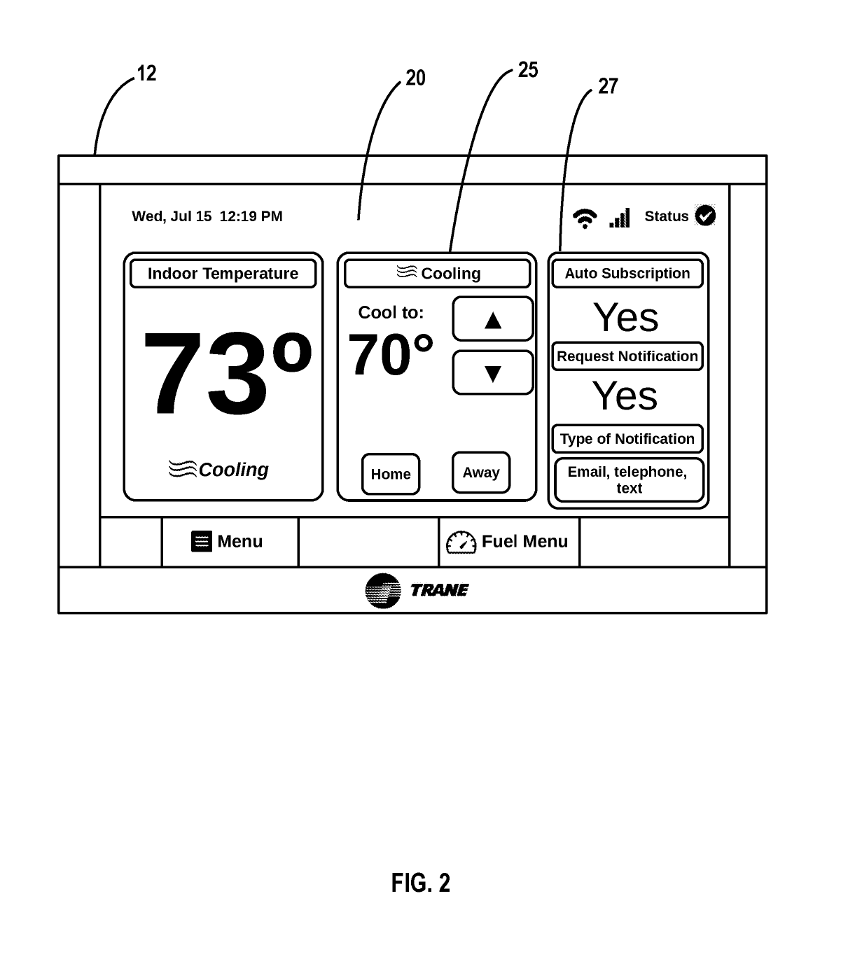

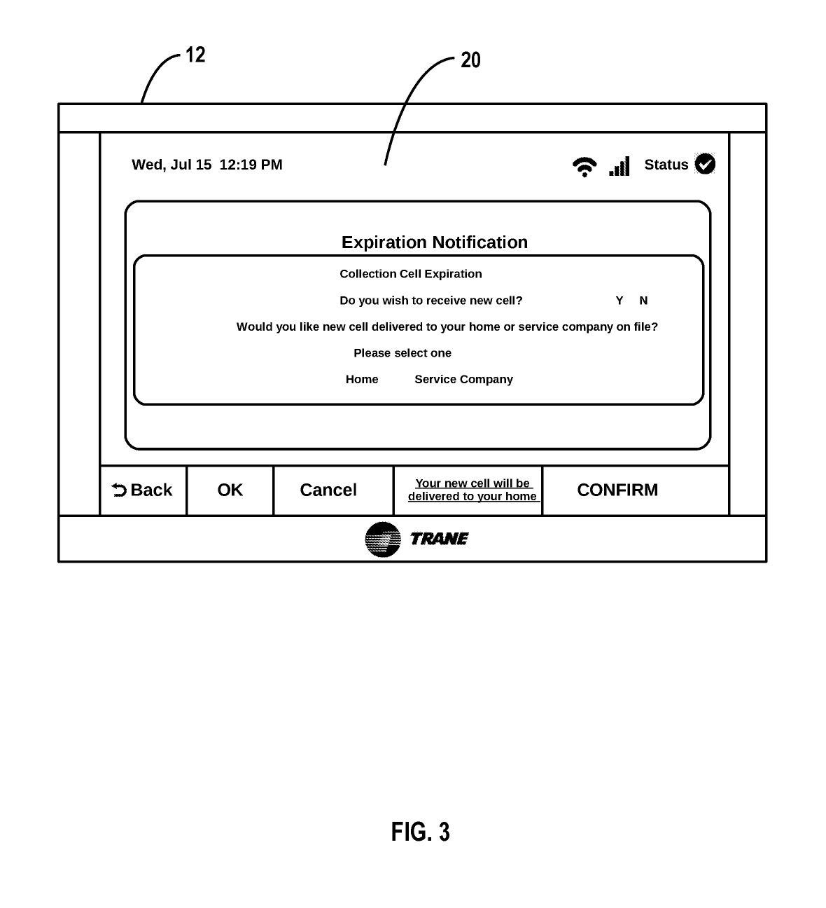

The touch screen 20, under the control of the processor 18 and in conjunction with the user interface 24, can display one or more graphical user interfaces (GUIs) for receiving a touch input from a user for selecting one or more various functions of the thermostat 12. For example, the touch screen 20 can display a GUI 25 for allowing a user to set the thermostat 12 to a desired temperature setting, or in accordance with the present disclosure, the touch screen 20 can display a GUI 27 that is configured for allowing a user to select an auto subscription service that is provided by the server 14 (see FIGS. 2 and 3, for example). The auto subscription service is a service that is provided by the manufacturer of the thermostat 12 or the HVAC system and it automatically reorders one or more peripheral components of the HVAC system when one of those components is no longer operable (i.e., a life of a component has expired), as will be described in greater detail below.

The HVAC interface 26, under the control of the processor 18 and in conjunction with the sensor 28, can monitor a status of one or more peripheral components 30 of the HVAC system. Some peripheral components that may be part of (or associated with) the HVAC system can include, without limitation, a humidifier, a humidifier pad, an ultraviolet light, an air filter, a media filter, a collection cell, a ventilation and system service, a filter screen, an electrode of an air filter, and an in force field filter (IFD).

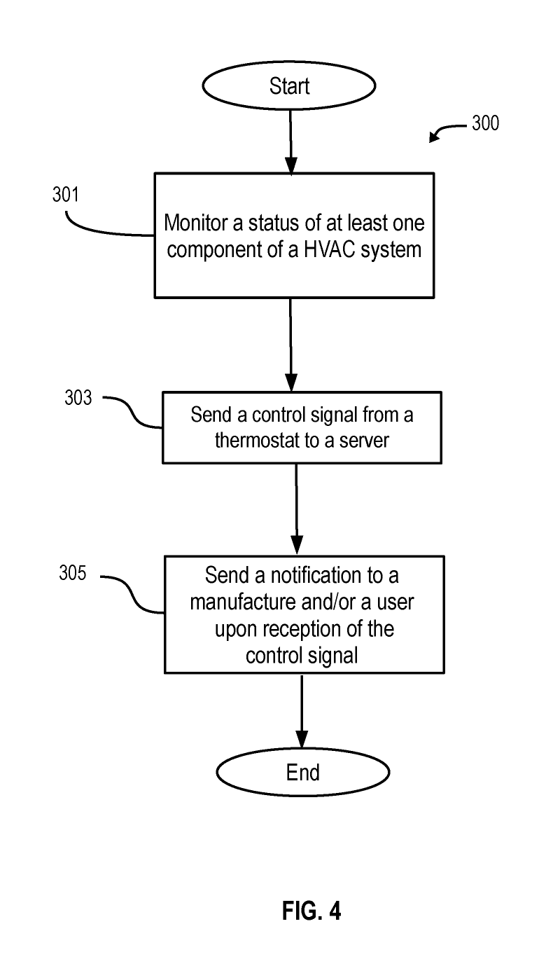

FIG. 4 is a flowchart of a method 300 for automatic replacement of peripheral components of the HVAC system, according to an embodiment of the present disclosure.

Initially, a user can enroll in an auto subscription service that is provided by a manufacturer (or dealer). For example, the user can use the thermostat 12 to enroll in the auto subscription service (FIG. 2). More particularly, the user can provide a touch input to an “auto subscription” GUI included in the GUI 27. In an embodiment, a first touch to the “auto subscription” GUI displays a “yes” GUI, and a second touch to the “auto subscription” field displays a “no” GUI (not shown). If the user wishes to enroll in the auto subscription service, the user can simply touch the “yes” GUI.

After the user enrolls to the auto subscription service, a “request notification” GUI will be displayed in the GUI 27, and this GUI can be configured similarly to the “auto subscription” GUI. The “request notification” feature notifies the user that a lifetime of one or more components of the HVAC system has expired. If the user selects the “request notification” feature, a “type of notification” GUI will be displayed, and this GUI allows the user to select a one or more types of notifications, e.g., an email, a telephone, a text, the thermostat 10, etc, that can be used to notify a user of the expired component.

Alternatively, the user can enroll in the auto subscription service using one or more other suitable methods. For example, the user can enroll directly to the auto subscription service via a server portal, e.g., the NEXIA® server portal.

The HVAC interface 26 and sensor 28 monitor one more of the previously described peripheral components of the HVAC system, at step 301, using various monitoring techniques. For example, with respect to monitoring the filters that can be used in the HVAC system, the HVAC interface 26 and sensor 28 can detect airflow through the filter, and send the detected airflow to the processor 18, which, in turn, can determine if there is sufficient airflow through the filters. One or more types of pressure sensors that measure pressure drop, before or after the filters, may be used by the HVAC interface 26 and sensor 28 for detecting airflow through the filter.

If the processor 18 determines that there is insufficient airflow through the filters, the processor 18 can send a control signal, via the network 16, to the server 14, at step 303, and the server 14 can send a notification to the manufacturer (and/or the user) of the thermostat 12 and/or the HVAC system, at step 305. Upon receipt of the notification, the manufacturer can automatically ship a new filter to the user, or the manufacturer can contact the user prior to shipping to confirm ordering of the replacement peripheral component.

In an embodiment, prior to or after the control signal is sent to the server 14, the processor 18 can also send a notification to the user notifying the user of the expired peripheral component, thereby allowing the user to confirm (or cancel) ordering of the replacement peripheral component. For example, and with reference to FIG. 3, an “expiration notification” GUI can be displayed on the touchscreen 20 of the thermostat 12. The “expiration notification” GUI can indicate which component, e.g., collection cell, is no longer operable. The “expiration notification” GUI can prompt the user to choose whether they wish to receive the new cell, and if so, prompt a user to enter where the user would like the replacement cell shipped (e.g., to their home or somewhere else, e.g., a service company that is contracted to service the HVAC system). The “expiration notification” GUI can also prompt the user to confirm their selection.

In accordance with instant disclosure, the system 10 including the thermostat 12 (or a controller of the BAS) allows the thermostat 12 to act as a bridge between manufactures (or dealers) and their customers (users). Accordingly, the customer (user) need not worry about ordering replacement peripheral components of their HVAC system, and since worn out (or inoperable) peripheral components can be quickly replaced, overall performance of the HVAC system can be enhanced.

In addition, an HVAC system that includes the system 10 is capable of detecting/collecting trend data associated with one or more of the peripheral components of the HVAC system. The collected trend data can be used by the processor 18 and analyzed using one or more control algorithms to determine if the one or more of the peripheral components of the HVAC system are going to need replacing in the foreseeable future. For example, with respect to the filters of the HVAC system, during periods of known excessive use (e.g., during the summer months) of an air conditioner system of the HVAC system, the processor 18 can determine using the trend data that the filters will probably need replacing within those summer months.

Moreover, the trend data can be used for maintaining inventories in warehouses and/or distribution centers. For example, with respect to filters, during the summer months, the system 10 can automatically have the air filters shipped from the manufacturing facilities to the warehouses and/or the distribution centers, so that the warehouses and distribution centers are adequately stocked in anticipation of reorders of the air filters.

Furthermore, the server 14 can be configured to collect trend data from a plurality of processors that are located in a common region (or area), and the server 14 can use one or more control algorithms to analyze the collected trend data to predict an expiration of the one or more components of the HVAC system. For example, if the server 14 determines from the trend data that there is going to be excessive use of air conditioners of HVAC systems that are located in, for example, an area that is relatively hot during the summer months, the server 14 uses the analyzed trend data to predict which if any of the peripheral components of the HVAC system will expire, and communicates this information to the manufacturing facilities and/or the distribution centers, so that they can increase production or inventory (or have extra service technicians on hand) in anticipation of expiration of the one or more peripheral components associated with the HVAC systems.

Furthermore, the system 10 can be configured to ship some of the components directly to a customer and ship some of the components directly to a dealer/distributor. For example, components that can be installed by a customer (e.g., a filter), those components can be shipped directly to the customer. Conversely, components that can only be installed by a certified service technician (e.g., a printed circuit board (PCB), overflow switch, etc.) can be shipped to the dealer, who can then coordinate with a customer to schedule a service call to install the component.

From the foregoing and with reference to the various Figures, those skilled in the art will appreciate that certain modifications can also be made to the present disclosure without departing from the scope of the same. For example, while system 10 including the thermostat 12 has been described herein as being able to automatically replace peripheral components of the HVAC system, the present disclosure is not so limited. More particularly, the thermostat 12 can be configured to monitor, replace, or replenish other components, supplies, or fuels, including any internet of things (IoT) devices, e.g., battery operated device, refrigerator water filter, fuel tank level sensor, etc., that may be in operable communication with the thermostat 12. As can be appreciated, the thermostat 12 can be configured to monitor, replace or replenish the IoT devices and sensors in a manner as described above with respect to the one or more peripheral components.

### ASPECTS

It is noted that any of aspects 1-18 may be combined with each other in any suitable combination.

Aspect 1. A system configured for automatic replacement of peripheral components of a heating, ventilation and air condition (HVAC) system is provided. The system can include a thermostat in operable communication with at least one peripheral component of the HVAC system, and a server in operable communication with the thermostat and a manufacturer for providing the manufacturer with a status of the at least one peripheral component.

Aspect 2. The system of aspect 1, wherein the at least one peripheral component is one of a humidifier, a humidifier pad, an ultraviolet light, an air filter, a media filter, a collection cell, a ventilation and system service, a filter screen, an electrode of an air filter, and an in force field filter (IFD).

Aspect 3. The system of aspect 1, wherein the server is a dealer diagnostics portal associated with the manufacturer.

Aspect 4. The system of aspect 1, wherein the server sends a notification to one of the manufacturer and a user of the thermostat as a result of receiving a control signal from the thermostat.

Aspect 5. The system of aspect 4, wherein the notification is one of an email, a text, and a telephone call

Aspect 6. The system of aspect 1, wherein the thermostat is configured to provide a graphical user interface (GUI) that allows a user to enroll in an auto-subscription service provided by the server.

Aspect 7. The system of aspect 4, wherein depending on an auto-subscription service selected by the user, a notification is displayed on the thermostat either prior to or after the control signal is sent to the server, thereby allowing the user to confirm a reorder of the at least one peripheral component.

Aspect 8. A method for automatic replacement of peripheral components of a heating, ventilation and air condition (HVAC) system is provided. The method can include monitoring a status of at least one peripheral component of the HVAC system using a thermostat that is in operable communication with the at least one peripheral component of the HVAC system and a server, sending a control signal from the thermostat to the server, and sending a notification to one of a manufacturer and a user of the thermostat upon receiving the control signal.

Aspect 9. The method of aspect 8, further comprising displaying a graphical user interface (GUI) that allows a user to enroll in an auto-subscription service provided by the server.

Aspect 10. The method of aspect 9, further comprising processing a subscription to the auto-subscription service.

Aspect 11. The method of aspect 8, wherein the at least one peripheral component is one of a humidifier, a humidifier pad, an ultraviolet light, an air filter, a media filter, a collection cell, a ventilation and system service, a filter screen, an electrode of an air filter, and an in force field filter (IFD).

Aspect 12. The method of aspect 8, wherein the server is a dealer diagnostics portal associated with the manufacturer.

Aspect 13. The method of aspect 8, further comprising sending by the server a notification to one of the manufacturer and a user of the thermostat as a result of the server receiving a control signal from the thermostat.

Aspect 14. The method of aspect 12, wherein sending the notification includes one of sending an email, a text, and a telephone call.

Aspect 15. The method of aspect 8, further comprising, depending on an auto-subscription service selected by the user, displaying a notification on the thermostat, either prior to or after the control signal is sent to the server, thereby allowing the user to confirm a reorder of the at least one peripheral component.

Aspect 16. A building automation system (BAS) for controlling a heating, ventilation and air condition (HVAC) system is provided. The BAS includes a processor in operable communication with at least one peripheral component of the HVAC system and a server that is in operable communication with a manufacturer for providing the manufacturer with a status of the at least one peripheral component when the server receives a control signal generated by the processor.

Aspect 17. The BAS of Aspect 16, wherein the at least one peripheral component is one of a humidifier, a humidifier pad, an ultraviolet light, an air filter, a media filter, a collection cell, a ventilation and system service, a filter screen, an electrode of an air filter, and an in force field filter (IFD).

Aspect 18. The BAS of aspect 16, wherein the server is a dealer diagnostics portal associated with the manufacturer.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A system configured for automatic replacement of peripheral components of a heating, ventilation and air condition (HVAC) system, the system comprising:
a thermostat in operable communication with at least one peripheral component of the HVAC system; and
a server in operable communication with the thermostat and a manufacturer for providing the manufacturer with a status of the at least one peripheral component.

2. The system of claim 1, wherein the at least one peripheral component is one of a humidifier, a humidifier pad, an ultraviolet light, an air filter, a media filter, a collection cell, a ventilation and system service, a filter screen, an electrode of an air filter, and an in force field filter (IFD).

3. The system of claim 1, wherein the server is a dealer diagnostics portal associated with the manufacturer.

4. The system of claim 1, wherein the server sends a notification to one of the manufacturer and a user of the thermostat as a result of receiving a control signal from the thermostat.

5. The system of claim 4, wherein the notification is one of an email, a text, and a telephone call.

6. The system of claim 1, wherein the thermostat is configured to provide a graphical user interface (GUI) that allows a user to enroll in an auto-subscription service provided by the server.

7. The system of claim 4, wherein depending on an auto-subscription service selected by the user, a notification is displayed on the thermostat either prior to or after the control signal is sent to the server, thereby allowing the user to confirm a reorder of the at least one peripheral component.

8. A method for automatic replacement of peripheral components of a heating, ventilation and air condition (HVAC) system, the method comprising:
monitoring a status of at least one peripheral component of the HVAC system using a thermostat that is in operable communication with the at least one peripheral component of the HVAC system and a server;
sending a control signal from the thermostat to the server; and
sending a notification to one of a manufacturer and a user of the thermostat upon receiving the control signal.

9. The method of claim 8, further comprising displaying a graphical user interface (GUI) that allows a user to enroll in an auto-subscription service provided by the server.

10. The method of claim 9, further comprising processing a subscription to the auto-subscription service.

11. The method of claim 8, wherein the at least one peripheral component is one of a humidifier, a humidifier pad, an ultraviolet light, an air filter, a media filter, a collection cell, a ventilation and system service, a filter screen, an electrode of an air filter, and an in force field filter (IFD).

12. The method of claim 8, wherein the server is a dealer diagnostics portal associated with the manufacturer.

13. The method of claim 8, further comprising sending by the server a notification to one of the manufacturer and a user of the thermostat as a result of the server receiving a control signal from the thermostat.

14. The method of claim 12, wherein sending the notification includes one of sending an email, a text, and a telephone call.

15. The method of claim 8, further comprising, depending on an auto-subscription service selected by the user, displaying a notification on the thermostat, either prior to or after the control signal is sent to the server, thereby allowing the user to confirm a reorder of the at least one peripheral component.

16. A building automation system (BAS) for controlling a heating, ventilation and air condition (HVAC) system, the BAS comprising:
a processor in operable communication with at least one peripheral component of the HVAC system and a server that is in operable communication with a manufacturer for providing the manufacturer with a status of the at least one peripheral component when the server receives a control signal generated by the processor.

17. The BAS of claim 16, wherein the at least one peripheral component is one of a humidifier, a humidifier pad, an ultraviolet light, an air filter, a media filter, a collection cell, a ventilation and system service, a filter screen, an electrode of an air filter, and an in force field filter (IFD).

18. The BAS of claim 16, wherein the server is a dealer diagnostics portal associated with the manufacturer.
